(19) United States
(12) Patent Application Publication
(10) Pub. No.: US 2006/0187207 A1
(43) Pub. Date: Aug. 24, 2006

(54) Mouse and portable computer for receiving the same

(76) Inventors: Ten-Long Dan, Taipei (TW); Yu-Hsien Chen, Taipei (TW)

Correspondence Address: RABIN & Berdo, PC, 1101 14TH STREET, NW, SUITE 500, WASHINGTON, DC, 20005, US

(21) Appl. No.: 11/340,466

(22) Filed: Jan. 27, 2006

(30) Foreign Application Priority Data
Feb. 21, 2005 (TW) 94105115

(51) Int. Cl. G09G 5/08

(52) U.S. Cl. 345/163

(57) ABSTRACT

A mouse for receiving in the portable computer is provided. The mouse includes a main body and a button portion. The body has a first side and a second side. The first side can be installed in a plugging slot of the portable computer. The button portion is electrically connected to the main body.

This application claims the benefit of Taiwan application Serial No. 94105115, filed Feb. 21, 2005, the subject matter of which is incorporated herein by reference.

### BACKGROUND OF THE INVENTION

1.Field of The Invention

The present invention relates to a mouse, and more particularly, to a mouse and a portable computer for receiving the same.

2. Description of the Related Art

A mouse, a keyboard, and a touch pad are usually used as input devices for inputting signals to the portable computer. The keyboard and touch pad are usually disposed on the portable computer, while the mouse is an accessory. However, the mouse is easier and more convenient in operating than the touch pad for users. Thus, the user often carries the mouse with the portable computer even though the mouse is not disposed directly on the portable computer.

On the other hand, in order to use the mouse, an additional connector is necessary for plugging into the portable computer, and more space is needed for containing the mouse, no matter using a wiring mouse or a wireless mouse. It is very inconvenient for the user.

In addition, the user needs to change a battery or provide additional charging process for the wireless mouse if the power of the wireless mouse is exhausted. It is troublesome matter for the user.

### SUMMARY OF THE INVENTION

It is an aspect of the present invention to provide a mouse and a portable computer for receiving the same. The mouse is easily carried with the portable computer. And the portable computer directly charges the mouse.

According to the aforementioned aspect of the present invention, a mouse is provided, which is received in a portable computer with a plugging slot. The mouse comprises: a main body and a button portion. The main body can be installed in the plugging slot of the portable computer.

According to the aforementioned aspect of the present invention, a portable computer is provided. The portable computer includes a host and a mouse. The host has a plugging slot. The mouse is received in the portable computer. The mouse has a main body, which can be installed in the plugging slot of the host.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 depicts a perspective view showing a wireless mouse received in a portable computer in accordance with a preferred embodiment of the present invention;

FIG. 2A depicts a front perspective view showing a wireless mouse in accordance with a preferred embodiment of the present invention;

FIG. 2B depicts a back perspective view showing a wireless mouse in accordance with a preferred embodiment of the present invention;

FIG. 2C depicts a side view showing a wireless mouse when rotating in accordance with a preferred embodiment of the present invention; and

FIG. 2D depicts a perspective view showing a wireless mouse when rotating in accordance with a preferred embodiment of the present invention.

### DETAILED DESCRIPTION OF THE PREFERRED EMBODIMENT

The preferred embodiment of present invention discloses a mouse, which is received in a computer. The mouse includes: a main body and a button portion. The main body has a first side and a second side. The first side can be preferred installed in a plugging slot of the computer. The button portion electrically connected to the second side of the main body for inputting signals to the computer. The mouse could be a wireless or wiring mouse.

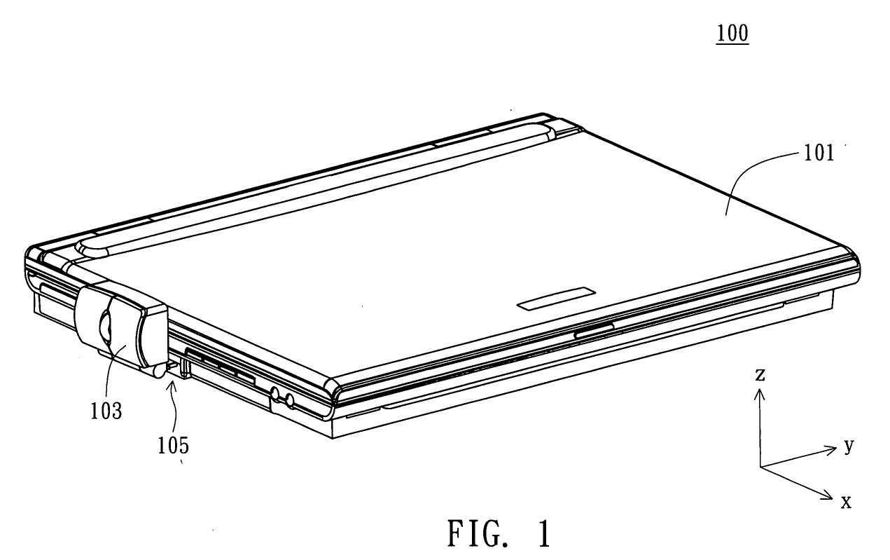

Reference is made to FIG. 1, which depicts a perspective view showing a wireless mouse received in a portable computer in accordance with a preferred embodiment of the present invention. The portable computer 100 includes: a host 101 and a wireless mouse 103. The wireless mouse 103 is connected to a plugging slot 105, which is formed on a side of the portable computer 100. The plugging slot 105 may conform to any interface standards, and is preferably conforming to a personal computer memory card international association (PCMCIA) interface standard.

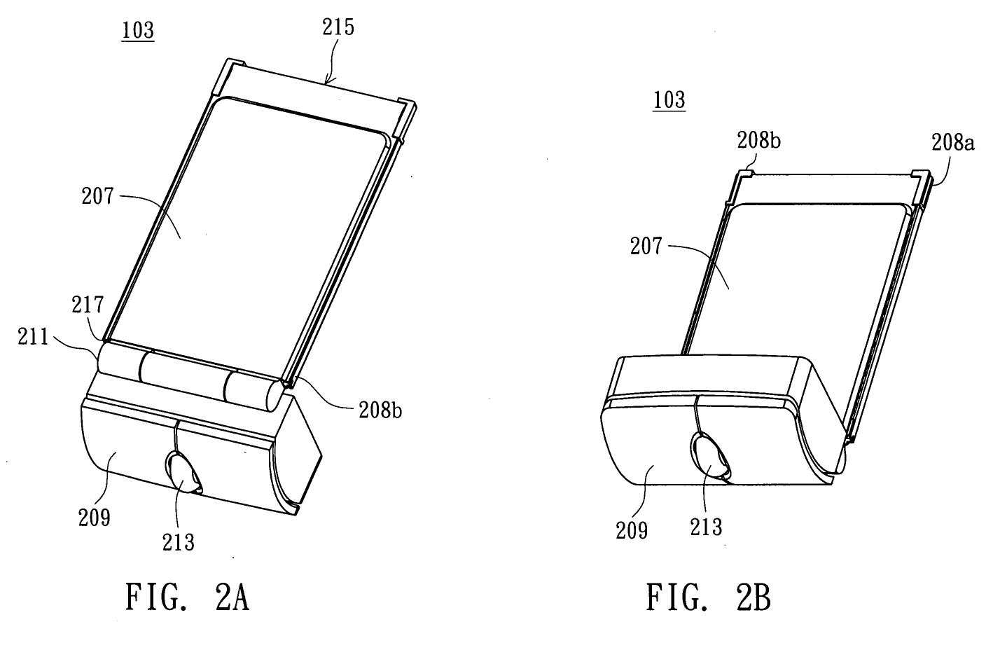

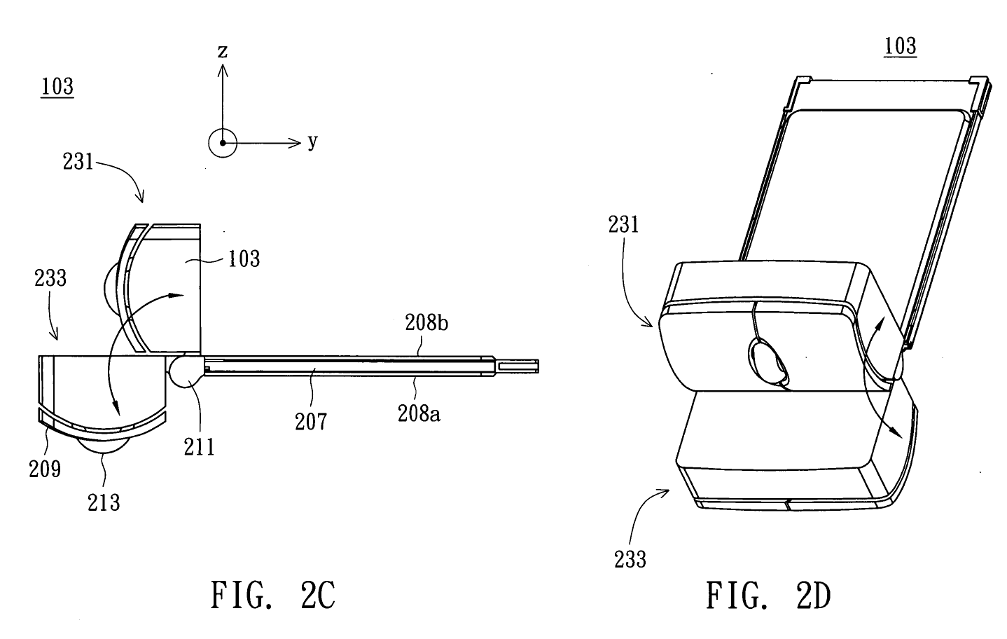

Reference is made both to FIGS. 2A and 2B, which depict a front perspective view and a back perspective view showing a wireless mouse in accordance with a preferred embodiment of the present invention. The wireless mouse 103 includes: a main body 207, a button portion 209, a first pivot 211, a top cover 208a, and a bottom cover 208b. The main body 207 has a first side 215 and a second side 217. The first side 215 corresponding to the second side 217 is electrically coupled with the plugging slot 105 of the portable computer 100. The button portion 209 is electrically coupled with the second side 217 of the main body 207 for controlling the wireless mouse 103. The top cover 208a and the bottom cover 208b respectively cover two surfaces of the main body 207, for protecting and fixing the main body 207. The first pivot 211 can be installed between the button portion 209 and the main body 207, so that the button portion 209 could rotate around the main body 207.

Referring to FIGS. 1, 2C and 2D, which depict a side view and a perspective view showing a wireless mouse when rotating in accordance with a preferred embodiment of the present invention. When the main body 207 of the wireless mouse 103 is inserted in the portable computer 100, the button portion 209 rotates around the X axis by the first pivot 211 to be into a received position 231 relative to the main body 207. When the button portion 209 rotates around the X axis by the first pivot 211 to be into an operating position 233, the user can use the wireless mouse 103 on a desk or a mouse pad freely. In the preferred embodiment of the present invention, the button portion 209 can further increase the degree of freedom by adding a second pivot or a third pivot for rotating around the Y axis or Z axis, as shown in FIGS. 1 and 2C. For example, a saddle joint, or a ball and socket joint can be used for the button portion 209 adding a second and a third rotating dimensions, such as the Y axis or Z axis. Furthermore, there could be no rotating relationship between the button portion 209 and the main body 207. That is, the button portion 209 is fixed on the main body 207, so that the plugging slot 105 is only a receiving space for the wireless mouse 103. In addition, the wireless mouse 103 is not limited to the two-button type, such as the button portion 209 as shown in FIG. 2A. The wireless mouse 103 can also use a three-button type or a track ball type as an inputting device. Moreover, a flat cable, such as a flexible flat cable, can be used as an electrical connecting and transmitting interface between the button portion 209 and the main body 207. And the signals from the button portion 209 are transferred to the computer by wireless transmitting process. The power that the wireless mouse 103 needs is provided by the host 101 via a plugging slot connected to the first side 215 of the wireless mouse 103. The plugging slot of the present invention is not limited to conforming to the PCMCIA interface standard. The plugging slot conforming to other standard interfaces, such as RS232, 1394, or Universal Serial Bus (USB) interfaces, etc, can also be used.

As mentioned above, the first side of the wireless mouse 103 is adapted to the slot conforming to PCMCIA interface standard. The user can draw the wireless mouse 103 directly from the plugging slot of the portable computer without carrying additional mouse with the portable computer. Furthermore, the pivot of the wireless mouse is used herein for reducing space and easily carrying for the portable computer. In addition, the power is provided to the wireless mouse by the host via the plugging slot without additionally changing the battery by the user. The plugging slot of the present invention provides receiving space for the wireless mouse. Therefore, the wireless mouse of the present invention is a device with large convenience and competition in current market.

As is understood by a person skilled in the art, the foregoing preferred embodiments of the present invention are illustrated of the present invention rather than limiting of the present invention. It is intended that various modifications and similar arrangements be included within the spirit and scope of the appended claims, the scope of which should be accorded the broadest interpretation so as to encompass all such modifications and similar structure.

What is claimed is:

1. A mouse received in a portable computer, the portable computer having a plugging slot, the mouse comprising:
a main body can be installed in the plugging slot of the portable computer; and a button portion electrically coupled the main body.

2. The mouse according to claim 1, further comprising a first pivot disposed between the button portion and the main body, and the button portion rotatable around the main body.

3. The mouse according to claim 1, further comprising a first pivot and a second pivot, and the button portion rotatable around the first pivot and the second pivot.

4. The mouse according to claim 1, further comprising a first pivot, a second pivot and a third pivot, and the button portion rotatable around the first pivot, the second pivot and the third pivot.

5. The mouse according to claim 1, wherein the mouse is charged in the plugging slot.

6. The mouse according to claim 1, further comprising a top cover and a bottom cover, the top cover and the bottom cover respectively covering two surfaces of the main body.

7. The mouse according to claim 1, wherein the plugging slot conforms to a personal computer memory card international association (PCMCIA) interface standard.

8. The mouse according to claim 1, the main body having a first side and a second side, the first side can be installed in the plugging slot of the portable computer; and a button portion electrically coupled with the second side.

9. A portable computer, comprising:
a host, t having a plugging slot; and
a mouse, received in the portable computer, the mouse having a main body can be installed in the plugging slot of the host.

10. The portable computer according to claim 8, wherein the mouse further comprises a button portion electrically coupled with the main body.

11. The portable computer according to claim 9, wherein the mouse further comprises a first pivot disposed between the button portion and the main body, and the button portion is rotatable around the main body.

12. The portable computer according to claim 9, wherein the mouse further comprises a first pivot and a second pivot, and the button portion is rotatable around the first pivot and the second pivot.

13. The portable computer according to claim 9, wherein the mouse further comprises a first pivot, a second pivot and a third pivot, and the button portion is rotatable around the first pivot, the second pivot and the third pivot.

14. The portable computer according to claim 9, wherein the mouse is charged in the plugging slot.

15. The portable computer according to claim 9, wherein the mouse further comprises a top cover and a bottom cover, and the top cover and the bottom cover respectively cover on two surfaces of the main body.

16. The portable computer according to claim 9, wherein the plugging slot conforms to a PCMCIA interface standard.

17. The portable computer according to claim 9, the main body having a first side and a second side, the first side can be installed in the plugging slot of the portable computer.

18. The portable computer according to claim 17, wherein the mouse further comprises a button portion electrically coupled with the main body.
